(19) United States
(12) Patent Application Publication
(10) Pub. No.: US 2008/0089987 A1
(43) Pub. Date: Apr. 17, 2008

(54) Continuous Intermeshing Agitator Food Cooker

(76) Inventor: Darrell C. Horn, Santa Rosa, CA (US)

Correspondence Address: STAINBROOK & STAINBROOK, LLP, 412 AVIATION BOULEVARD, SUITE H, SANTA ROSA, CA, 95403, US

(21) Appl. No.: 11/871,884

(22) Filed: Oct. 12, 2007

Related U.S. Application Data
(60) Provisional application No. 60/851,654, filed on Oct. 12, 2006.

(51) Int. Cl. A23L 1/01; A47J 27/04; A47J 36/00

(52) U.S. Cl. 426/510; 99/331; 99/332; 99/348

(57) ABSTRACT

A method and apparatus for continuous cooking of a pumpable food product including a process chamber 20 having an inlet end 22 and an inlet port 24 for introducing food product 12 into the chamber, an outlet end 26 and an outlet port 28 for the discharge of the cooked food product 14, and a central portion between the two ends with a plurality of steam inlets 32 arrayed along the walls of the central portion; inside the chamber at least two non-conveying agitator 80 with arms 86 depending for mixing and kneading food product; a drive means 90 for the agitators; a loading device 102 to feed a pump 100 that introduces food to the cooking chamber and provides the motivation to discharge the cooked food product through the outlet; and a controller 110 that monitors and controls the inlet pump, the steam inlet valves and the agitator speed and direction which all impact the quality characteristics of the cooked food product.

### CROSS REFERENCES TO RELATED APPLICATIONS

The present application claims the benefit of U.S. Provisional Patent Application Ser. No. 60/851,654, filed Oct. 12, 2006 (Oct. 12, 2006).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### FIELD OF THE INVENTION

The present invention relates generally to commercial cooking apparatus, and more particularly to a continuous steam cooker having intermeshing, non-conveying agitators, specially adapted for cooking pasta filata cheese.

### BACKGROUND DISCUSSION OF RELATED ART

There are a variety of different continuous direct steam cooking systems in use today. Most of the continuous direct steam cooking systems are designed with an auger or screw to convey the product through the cooker. This type of cooker does not mix the product effectively since the conveying screw cannot be rotated fast enough. The lack of mixing causes the direct steam injected into the product to over cook some product near where the steam is injected into the product as the product is slowly conveyed through the cooker.

There are other cookers that use two conveying agitators which have a series of solid flight sections down the length of the agitators with mixing sections between the flights to mix product. An example of this type of cooker is shown in patent (U.S. Pat. No. 6,487,962) which depends on solid flights to push the bed of rice or pasta forward as the agitators turn and mix the product by automatically reversing the agitators frequently. These cookers are effective on relatively viscous products such as rice or pasta where the bed of product can be pushed by the solid flight sections, however, are ineffective for cooking difficult to mix products such as stiff cheese products or fruit fillings since the agitators cannot be rotated fast enough to result in effective mixing. With solid flight agitators, the injected steam is not effectively mixed into the stiff product resulting in an uneven cook of stiff, doughy type products such as ground meat or mozzarella cheese. In the case of pasta filata or mozzarella cheese (which is a type of pasta filata cheese), which is a very difficult product to cook, there can be over cooked and under cooked areas of product resulting in separation of the moisture and milk solids from the product. In the case of cooking fruit fillings or ground beef, if the product is heated unevenly, there can be overcooked pieces in the final product.

Another type of continuous cooking machine with two side by side agitators is a machine called a Continuous Compartmented Mixer (International U.S. Pat. No. 5,083,506). This machine controls the movement of slurries with a solid flight section moving through a wall between adjacent walled compartments. This system is effective for some applications but still is limited because the throughput of the machine is a function of the RPM (revolutions per minute) of the agitators.

One of the most effective systems for cooking liquid products is a machine called a RotaTherm, manufactured and sold by Gold Peg International Party, Ltd, of Moorabin, Victoria, Australia. The cooking barrel of the RotaTherm system is vertical with the product entering at the bottom of the cooker barrel and exiting out of the top of the barrel. The agitator motor is positioned at the bottom of the cooker body below the product inlet and drives the agitator at varying RPM to mix the steam into the product, heating it to the set point temperature, before it exits the cooker barrel out of the top. This machine works well on non-viscous products where the single agitator does an effective job of mixing the thin jet of steam from the steam injectors. However, when cooking stiffer products such as mozzarella cheese or other semi-solid products, the product rotates with the agitator as it is pumped through the cooking column of the machine and little mixing occurs. As a result the jet of steam heats a spiral strip of product as the product rotates with the agitator and over heats some of the mozzarella cheese curd causing excessive separation of the milk solids and moisture from the mozzarella cheese resulting in a poor quality of cheese with low yield.

An additional problem of the RotaTherm design is created by the concentrated jet of steam coming from each injector. The nozzles are designed to focus the steam jet in a way that the steam does not wash over the outside of the curd but instead penetrates into the curd plug. The single agitator does not mix the product, so the jet of steam must penetrate the plug to disrupt the flow of product and partially heat the center of the plug to attempt to make up for the lack of agitator mixing. These penetrating jets of steam partially compensate for the ineffectiveness of the agitator at the expense of product quality. This harsh steam jet overheats the product adjacent to the jet of steam leaving product undercooked that is not directly contacted by the steam jet. In addition this jet of steam bores through the product and heats the center shaft of the single agitator resulting in over heating of the metal in the agitator shaft requiring complicated and expensive water-cooling of the hollow agitator shaft.

A second version of the above type of machine, similar to the RotaTherm, positions the cooking column horizontally to use gravity to provide better mixing. This type of cooker improves the mixing of the single agitator but not enough to eliminate the uneven mixing and uneven heating with the concentrated jets of steam when processing viscous products such as mozzarella cheese.

The heated temperature of mozzarella cheese must be carefully controlled within a few degrees. If mozzarella cheese is over heated moisture and milk solid separation will occur and if under heated the cheese curd will not fuse together. Control of final product temperature of mozzarella cheese is so critical that the standard method of making mozzarella cheese is to heat and mix it submerged in hot water. It is much easier to control the temperature of the hot water and thus indirectly control the temperature of the cheese curd during the cooking and mixing processes. The other critical part of making mozzarella cheese is that it must be stretched as it is heated to align the molecular chain of the cheese to get the proper stringy texture of the finished product. This combination of temperature control and stretching has not been possible with any continuous system that does not utilize heating and mixing while submerged in hot water. The conventional way of heating and stretching mozzarella cheese submerged in water is inefficient and the milk solids dissolve in the water creating loss of milk solids in the water that lowers yields.

Neither of these two single agitator systems, vertical or horizontal RotaTherm, do any stretching of the mozzarella curd as it is heated. Since the single agitator of both types of cookers simply rotates the stiff mozzarella curd plug around shaft with the agitator rotation, there is little or no relative motion of the cheese curd with the agitator components to stretch the mozzarella curd. Stretching of the mozzarella cheese curd is important to align the cheese molecular chain which gives the cheese stretch ability characteristics or elasticity as well as texture often referred to as ‘chicken breast’ texture.

Cooking, heating and stretching processes are of unique importance for the manufacture of pasta filata cheese including mozzarella cheese. The key to quality of mozzarella cheese and other forms pasta filata cheeses is the relationship between cheese curd pH after coagulating/milling and cheese curd temperature in the cooking/stretching process. The relationship between these two variables directly affect moisture content of the finished cheese and, in turn, body and mouth feel of the cheese. Selection of culture and culture conditions has provided processors with a great deal of control over the coagulant activity and final curd pH. Traditional methods of processing the cheese curd in hot water, however, have been relied upon for the cooking/stretching. Scientific literature has clearly demonstrated the purpose and importance of the control of the heating process on cheese quality.

In the production of mozzarella cheese, cooking/stretching is applied for several reasons: 1) plasticization of the cheese; 2) de-naturation of coagulant; 3) decrease of starter population; and 4) texture development.

To a point, increased temperature during the cooking/stretching treatment promotes absorption of the whey protein and water holding capacity, however excessive heating causes irreversible protein denaturation. Research by the Northeast Dairy Foods Research Center, Department of Food Science, 118 Stocking Hall, Cornell University, Ithaca, N.Y. 14853 has shown that even slight increases in cook temperature above the recommended maximum temperature results in cheese with a lower moisture content and decreases proteolysis. Macroscopically, higher temperatures cause a shrinking of the protein matrix and release of moisture and, with it, soluble milk solids. In fact, at temperatures approaching and exceeding the boiling point of water, casein will irreversibility aggregate, causing a loss of solubility and lower water binding functionality. This problem is amplified as the pH of the cheese approaches the isolectric point. The net affect is lower quality cheese with impaired brown-ability and reduced yield.

The importance of the control over the cooking/stretching treatment cannot be understated. Cooking systems which focus steam energy into small regions, such as is caused by focused direct steam injection into the cheese curd plug through a hole in the cooker wall, causes small regions of the product to attain a higher temperature and potential for severe de-naturation. The single agitator cooking systems attempt to overcome such problems by increasing agitator RPM to promote uniform heating, resulting in a loss of stretch-ability and water holding capacity which inevitably results in lower yields and poor cheese texture and mouth feel. Of paramount importance is precise and uniform temperature distribution within the cooking process which the single agitator cookers with focused steam injection cannot achieve.

One measure of the quality of the mozzarella cheese is the way the cheese melts and browns when heated on a pizza. It is desirable for the cheese to melt evenly and, in addition, brown with an even distribution of uniformly sized and colored blisters. It has been found that if the cheese is mixed with too much shear the desired melt characteristics deteriorate. With too much shear the size and color of blisters will not be uniform. High RPM of an agitator will cause high shear of the cheese. Since the single agitator cookers require high RPM to approach the required mixing of the product, this causes high shear and a poor melt characteristic will result.

Mozzarella cheese is particularly sensitive to over heating and uneven heating. The protein in the cheese curd is capable of holding more moisture if the protein is not over heated. If over heated, it becomes less soluble and separates from the moisture resulting in moisture release from the cheese. This moisture release carries with it milk whey and milk solids resulting in significant yield loss. The moisture loss results in mozzarella cheese that is more tough and has less stretch, the loss of which lowers the quality of the mozzarella cheese.

The appearance and texture of melted cheese on pizza is discussed in U.S. Pat. No. 5,902,625 which is for a process of making a soft or semi-soft fibrous cheese. Their method relies on introducing food additives to the cheese making process to improve the melted cheese characteristics. It is desirable, however, to develop a heating/stretching system that does not rely on food additives to improve the melted cheese characteristics.

The two types of cookers mentioned above, vertical RotaTherm or horizontal agitator cooker, are reasonably effective when cooking homogeneous products and are not as effective when cooking products that have particulates that tend to separate from the liquid ingredients of the product. When cooking homogeneous products, such as processed cheese, the vertical agitator of the RotaTherm work reasonably well because the ingredients that make up the product do not separate as they are pumped through the cooker barrel. The steam is injected perpendicular to the side wall of the cooker body to heat the fluid product. When cooking a non-viscous homogeneous product the agitator can be operated at a high RPM (between 800-1500 RPM) mixing the steam into the product for reasonably even heating.

A second problem created by the poor mixing of the vertical RotaTherm and horizontal agitator cooker is the uneven heating of products with particulates. If the product has particulates or other ingredients with different densities that tend to separate unless effectively blended, these two types of cookers will not keep the particulates in perfect suspension for even cooking unless the agitators are operated at high RPMs. However, at high RPMs the agitator can damage particulates further. A rotating single shaft agitator is a poor mixer when the agitator is operated at low RPM. The spinning of product about the agitator center shaft at high RPM tends to separate heavy particulates from the lighter particulates due to the centrifugal force applied to the product as the agitator spins. At high RPM the design shape of the agitator creates forces counter to the centrifugal force which will mix the heavier particulates with the lighter particulates. With this counter centrifugal design the forces that the agitator causes damages fragile particulates even more than high RPM.

There are many other applications where effective mixing at low RPM is required. The previous paragraph mentioned the challenge of cooking products with particulate ingredients that have different densities from the base liquid. If the particulate ingredients are soft and fragile, such as cooking diced beef or diced potato or diced vegetables, the product cannot be agitated vigorously or the particulates will be broken apart.

Continuous cooking systems must be designed for a limited range of throughputs. Most products are sensitive to under or over mixing so the dwell time in the cooker must be controlled. For this reason the range of production rates that any given size cooker will cook effectively is quite limited. This is contrary to the normal growth of a product line in a food factory. If a product has high quality and is marketed well, the sales of it will increase over the years. In order to deal with this growth operators must increase production. When they purchase continuous cooking equipment they typically must accurately project their future needs and then in the beginning only run the equipment for a few days per week, however, this does not always match downstream processes. As the product demand grows they add production days to the schedule. When the full capacity of that piece of equipment is reached they use more factory space and add another continuous cooker. This process of growth is very inefficient. The processor must purchase a larger machine than he needs in the beginning and occupy more factory space than he needs when he has low production requirements. When he reaches the capacity of one continuous system he must add expensive factory space and a second expensive machine system and go through the same inefficient growth pattern again.

The solution to this expensive growth process is to design equipment so that it is modular and can be expanded, however, existing continuous cookers are not modular and cannot be expanded to match production growth.

The foregoing prior art devices reflect the current state of the art of which the present inventor is aware. Reference to, and discussion of, this prior art is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### DISCLOSURE OF THE INVENTION

The present invention is a dual intermeshing agitator continuous direct steam cooker that receives a pump-able product from a positive displacement metering feed pump into the inlet end of the cooking chamber from the bottom and discharges the product out the discharge end at the top. The speed adjustable positive displacement metering pump determines the throughput rate of the product through the cooker. This throughput rate is completely independent of the RPM of the agitators, allowing the agitators to mix the product at the most optimal RPM necessary without changing the production throughput rate.

Down the center of the cooking barrel are two intermeshing agitators. The mixing rods of the agitators overlap each other as they rotate. The agitators are driven in a counter rotating direction timed by two meshing timing gears and driven by an electric motor through a gearbox. The RPM of the two agitators can be varied by the use of a variable frequency electric drive running the agitators at 100 to 1500 RPM.

The action of the intermeshing arms on each agitator imparts considerable mixing of the product even at low RPMs. At 1500 RPM the mixing is severe. This action is sufficient to adequately mix even the most difficult products such as mozzarella cheese. One surprising outcome of this intermeshing action is the stretching that is imparted to the mozzarella cheese. The intermeshing arms penetrate the cheese plug between the agitator shafts and then move apart as the agitators rotate. The action adds a gentle stretching of the cheese to align the molecular chain just like hand kneading under water of the original mozzarella cheese processing method. Increasing agitator RPM increases this stretching action, allowing the operator to control this important process variable. This, in combination with the very effective mixing, make this new invention perfect for continuously and automatically making mozzarella cheese.

The horizontal orientation of the cooking barrel has the advantage of using gravity to help mix product although a vertical orientation of the cooking barrel (not shown) would work also although not quite as efficiently. It is commonly known that a horizontal agitated blender is more efficient than a vertically agitated blender in blending a wide range of slurry and semi-slurry products. The affect of gravity on the product assists in keeping the product from cylindering (i.e., rotating with the agitator with resulting poor mixing). This affect in combination with the intermeshing design makes the horizontal, intermeshing mixing system very efficient and, therefore, the preferred embodiment of this invention.

Along the length of the cooking barrel are a series of steam injectors which inject live steam into the product to heat it. The steam injectors are a poppet valve design similar to the valves in an automobile engine. The poppet is flat on the end which contacts the food product and top held in the closed position with a spring and opens to allow steam to flow into the product when there is steam pressure to offset the spring force. An alternative to this method of opening and closing the poppet valve is to mount the poppet on the end of an air cylinder and mechanically or pneumatically directly control the poppet opening and closing.

Due to the shape of the top of the poppet when the steam pushes the poppet open, the steam is diffused into the product at the angle of the closing face of the poppet all 360 degrees around the poppet head. This spreads out the steam flow, (washing the steam over the outside of the product plug) directing it away from the center shaft of the two agitators allowing the two intermeshing agitators to distribute the steam out into the product over a significantly larger area than does the vertical or horizontal RotaTherm. This distribution of the steam from each poppet valve results in very even temperature throughout the product plug. As a result the agitator's center shafts do not get overheated so no water cooling of these shafts is necessary. However the greatest advantage is that the product is completely temperature equilibrated as it exits the cooker. This is particularly critical when cooking mozzarella cheese where temperature control (neither too hot nor too cold) is so critical.

Although the preferred embodiment of the steam injector is the poppet made of stainless steel with the flat face and the valve housing coated with food release coating such as Teflow, the poppet and valve housing around the poppet can be made of a high temperature plastic which will not transmit heat from the steam flow and cause burning on the surface of the steam injector poppet valve surface in contact with the product or the housing around it. This minimizes or eliminates product burn-on around the steam injector valve thus eliminating the necessity of water cooking the cooker barrel wall.

The design of the steam line upstream of the steam injector is unique also. In standard direct steam cookers, when the steam is turned off, steam in the line condenses causing a vacuum which can suck product into the valve chamber contaminating the steam injector valve. This invention adds a vacuum breaker in the line to each injector to break this vacuum and prevent this source of contamination. If direct control of the steam injector is used, the steam line is always pressurized therefore there is no problem of steam collapsing and product being sucked into the steam line.

The gentle, diffused method of injecting steam into the cooker greatly adds value to the use of this process system for making mozzarella cheese. This gentle and controlled steam washing over the surface of the cheese plug and being mixed evenly into the cheese by the two intermeshing agitators assures the operator's ability to control cheese temperature very accurately. This diffused steam injection combined with the mixing action of the intermeshing agitator arms completely solves the mozzarella cheese producer's problem of yield loss resulting from the use of the water immersion cooker-stretchers currently in common use today by providing an efficient direct stream heating system that replaces the traditional system.

The agitator design is also unique for making a wide range of other products that require either low shear or high shear mixing. Each mixing arm on the agitator shaft can be shaped like a tear drop. With this design the mixing action is low shear when rotating with the blunt edge in the leading direction. By reversing the agitator with the sharp edge moving in the leading direction the agitator imparts high shear to the product especially at the high end of the RPM range. This is important when processing products where the system needs to break down the product into smaller pieces during processing. When the objective is to avoid damaging the particulates such as vegetables like zucchini wheels, which are very fragile when cooked, the agitator is rotated at a very low RPM in the low shear direction with the blunt edge of the agitator moving in the leading direction.

For applications where very low shear is called for, a different agitator is used. This agitator arm has a round cross section. Running this round arm agitator in either direction of rotation at low RPM imparts almost zero shear to the product. Sensitive products such as whole fruit preserves, fruit pie fillings or tomato salsa must be cooked with minimal shear.

For some applications such as heating mozzarella cheese, additional agitator arms can be added to the agitator shafts increasing the total number of arms. The added agitator arms result in increased mixing at lower RPMs which maintains minimum shear while at the same time increases the mixing and stretching of the cheese to produce a better melt quality (evenly sized and colored blisters) when heating pizza topped with mozzarella cheese in a pizza oven.

The barrel orientation of the cooking chamber can be horizontal or vertical or anywhere in between depending on the product, to maximize mixing and heating performance. Most products will process better with the cooking barrel positioned horizontally, however, some products are less likely to have the steam condensate collect in the column if the orientation of the barrel is vertical or somewhat vertical.

The invention can be designed with short bolted together barrel sections to allow the length, and therefore the capacity, of the cooker to increase as the processor's market expands. Each barrel section is designed with the same number of steam injector ports so that by adding a section to the cooker barrel the number of steam injectors and therefore the heating capacity of the cooker is increased accordingly.

The feed system, drive system, control system and back pressure system on the basic cooker are all capable of handling higher production. This means that to increase production as much as 100% the processor only has to add a cooker barrel section and two agitator sections to make longer mixing agitators at a fraction of the cost of a new, larger cooker.

The agitators can be made in sections of molded plastic the same length as the barrel sections. The agitator sections slide over square stainless steel shafts and thus are expandable with additional barrel sections to accommodate an increase in the cooker barrel length.

By adding a special flow restriction valve downstream of the discharge of this continuous cooker and restricting the cooked cheese flow, this cooker can heat the cheese up to temperatures that are above boiling. This cooking barrel and all the components connected to the cooking barrel are designed to handle over atmospheric pressure. This facilitates heating the product continuously to temperatures up to 300 degrees F. and pressures up to 72 PSI (pounds per square inch) over pressure for aseptic processes.

The disclosure above is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

It is therefore an object of the present invention to provide a new and improved continuous cooking apparatus for pumpable food that can maintain narrow temperature ranges and not have under or over heated portions of the food.

It is another object of the present invention to provide a new and improved low shear mixing by employing two or more, non-conveying agitators with intermeshing arms.

A further object or feature of the present invention is a new and improved way of introducing steam into the cooking chamber so that it is more diffused and less damaging to the texture and structure of the food being cooked.

Another feature of the present invention is that it can be constructed in modules so that the apparatus can be lengthened to add more production capacity as required.

An even further object of the present invention is to provide a novel method of varying the rates of steam, agitation and pumping to affect the performance characteristics of the food being cooked.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1A is a front elevational view of the preferred embodiment of this invention;

FIG. 1B is a left side elevational view of FIG. 1A where the food product inlet is located;

FIG. 1C is a right side elevational view of FIG. 1A where the cooked product outlet is located;

FIG. 1D is a top plan view of FIG. 1A;

FIG. 2 is an enlarged cross-sectional view taken along lines 2-2 in FIG. 1A and FIG. 1D;

FIG. 3 is an enlarged cross-sectional view of a poppet valve in the area denoted by a dashed line 3-3 in FIG. 2;

FIG. 3A is a plan view of the top of the poppet valve shown in FIG. 3;

FIG. 4 is a top plan view of two agitators used in the preferred embodiment;

FIG. 4A is a end view of FIG. 4;

FIG. 5 is an enlarged cross-sectional view of an agitator taken along line 5 -5 in FIG. 4, showing the shape of an agitator arm;

FIG. 6 is an enlarged cross-sectional view of an agitator similar to FIG. 5 showing an alternate shape of an agitator arm;

FIG. 7 is an elevational view of an alternate embodiment of an agitator with additional arms added to increase mixing at low RPM;

FIGS. 7A-7I are cross-sectional views of agitator arms taken along lines indicated in FIG. 7;

FIG. 8A is a front elevational view of an alternate form of the preferred embodiment of this invention wherein the process chamber is segmented to allow the size of the cooker to be enlarged or reduced;

FIG. 8B is a top plan view of FIG. 8A;

FIG. 9 is a top plan view of an alternate form of a pair of agitators wherein the shafts are segmented to allow the size of the cooker to be lengthened or shortened;

FIG. 10 is a schematic diagram of the system of the preferred embodiment of this invention;

FIG. 11 is a flow chart of the steps in implementing the method of this invention; and

FIG. 12 shows another preferred embodiment of the agitators and agitator arms of the present invention.

### DETAILED DESCRIPTION OF THE INVENTION

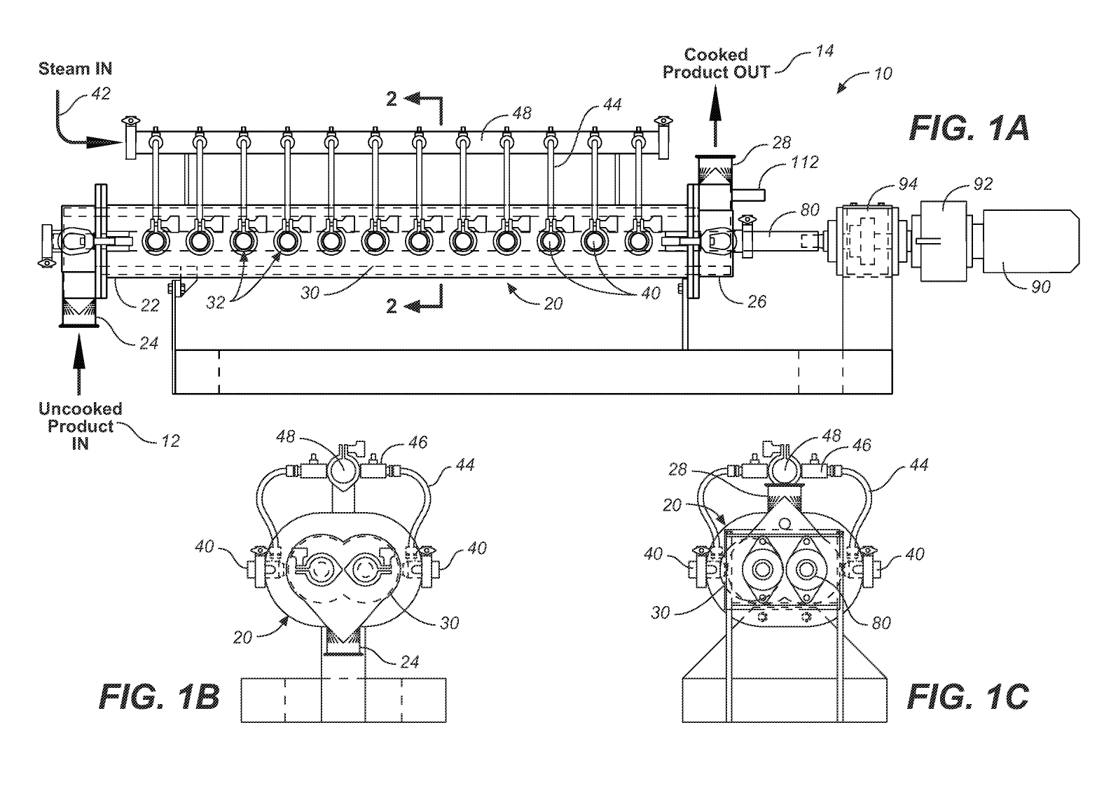

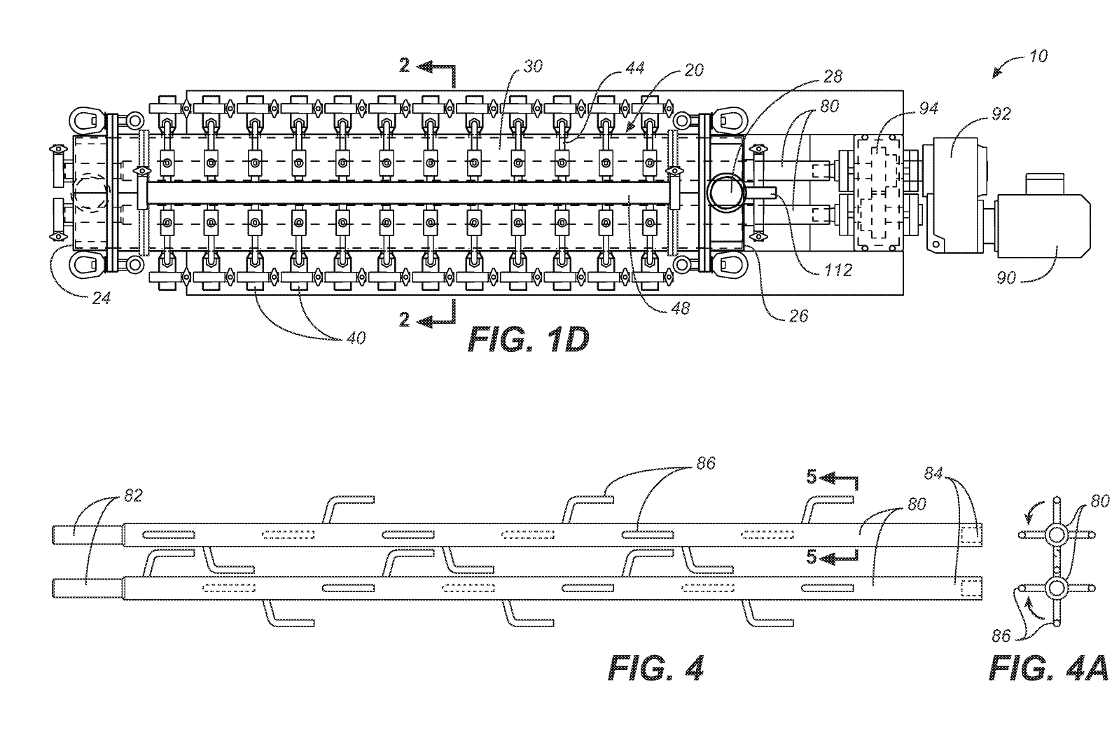

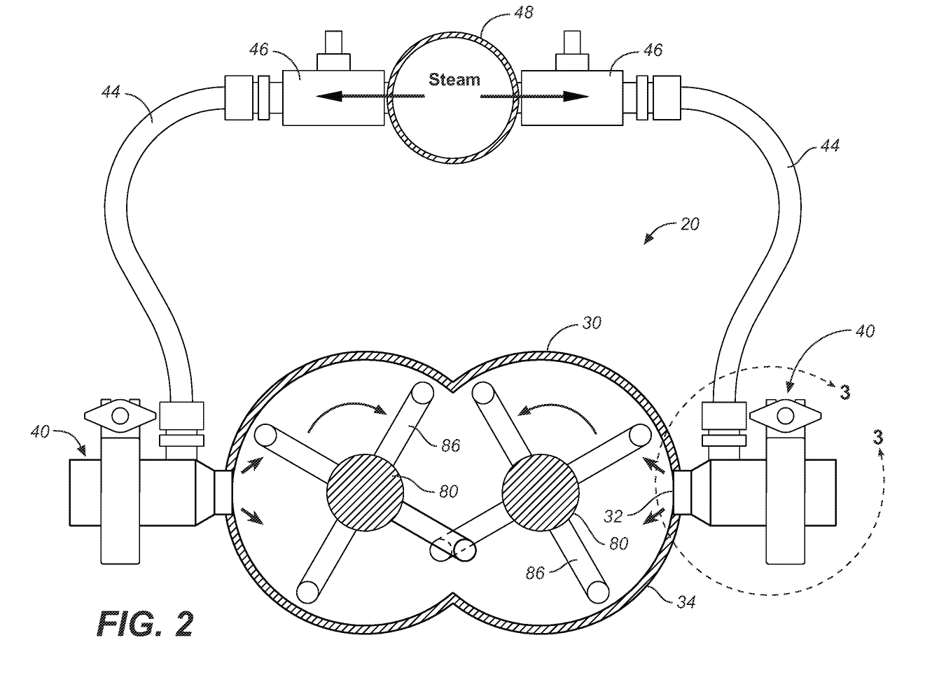

Referring to FIGS. 1-5, the present invention is generally denoted as 10. The cooking chamber 20 has an inlet side 22 with an inlet 24 and an outlet side 26 with an outlet 28. The central section 30 of the chamber between the ends has a plurality of steam inlets 32 arrayed along the chamber walls 34. Each steam inlet has a input valve 40 attached to the chamber wall and fed steam 42 via a line 42 from a control valve 46 attached to a manifold 48. The control valve 46 also has a vacuum breaker on the line 42 side to sense and compensate for a vacuum that may be caused in the poppet valve when closed. As steam cools and condenses it could suck food product into the valve.

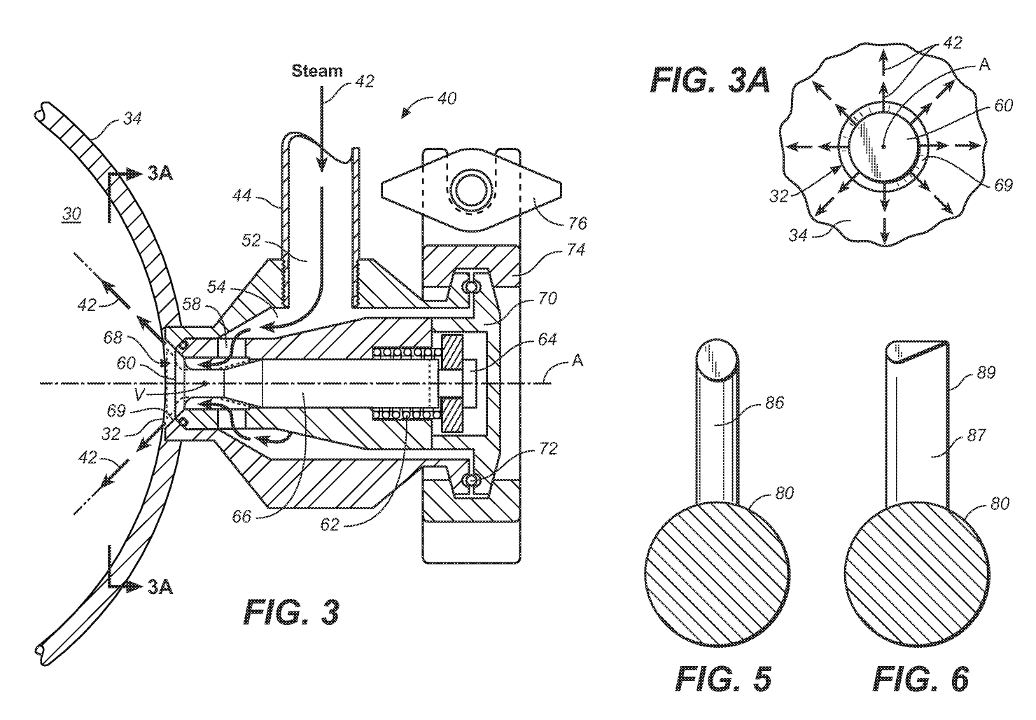

The poppet valve 40 has a valve body 50 that has an inlet 52 where steam 42 is delivered via line 44. The stainless steel poppet valve and housing are coated with a food release coating or may be made of high temperature plastic which will not transmit heat to the surrounding area which could cause product burn-on. This would also eliminate the need for cooling that portion of the cooker. The steam enters the main chamber 54 of the poppet valve which communicates with the valve head 60 via ports 58. The valve head in the preferred embodiment is flat and round with a tapered face that mates and seats perfectly into a round hole 68 with a chamfered edge 69. The same sort of valve closure is common on the intake and exhaust valves in gas engines. The valve is normally closed by a spring 62 located at the base 64 of the valve stem 66. When the pressure of the steam inside the main body of the poppet valve exceeds the retaining force of the spring, the valve stem will move thus allowing steam to enter the cooking chamber 30. The valve opening is designed to allow steam to flare out initially in a conical shape whose vertex is indicated at V (in FIG. 3) and whose base plane would be normal to axis “A” indicated in FIGS. 3 and 3A. This arrangement prevents food product from entering the poppet valve body as the steam pressure is greater than the pressure inside the cooking chamber.

The base 70 of the valve 40 is held against the valve body and seal 72 by a ring clamp 74 which is easily accessed and removed by loosening wing nut 76. This design facilitates quick disassembly, inspection and maintenance.

At least two agitators 80 are required in the preferred embodiment of the present invention. The distal ends 82 are rotatably mounted to the inlet side 22 of the cooking chamber 20. The proximal ends 84 go through the outlet end 26 and are coupled and synchronized at gear box 94 which is connected to a transmission 92 that is driven by motor 90.

Depending at regular spaced intervals from the agitators 80 are agitator arms 86. The preferred embodiment can be seen in FIG. 5 where the arms 86 are round in cross-sectional shape and impart very little spear to the food product. An alternate arm cross-sectional shape is shown in FIG. 6 where the arm 87 has a tear drop shape profile. The sharp edge 89 will impart significant shear to the food product when the agitator is rotated in the direction where the sharp edge 89 is leading.

Since the agitators are non-conveying, their rotation is independent of the product flow and strictly used for mixing and kneading the product. This is a tremendous advantage because low RPM agitators impart very little shear to the food product.

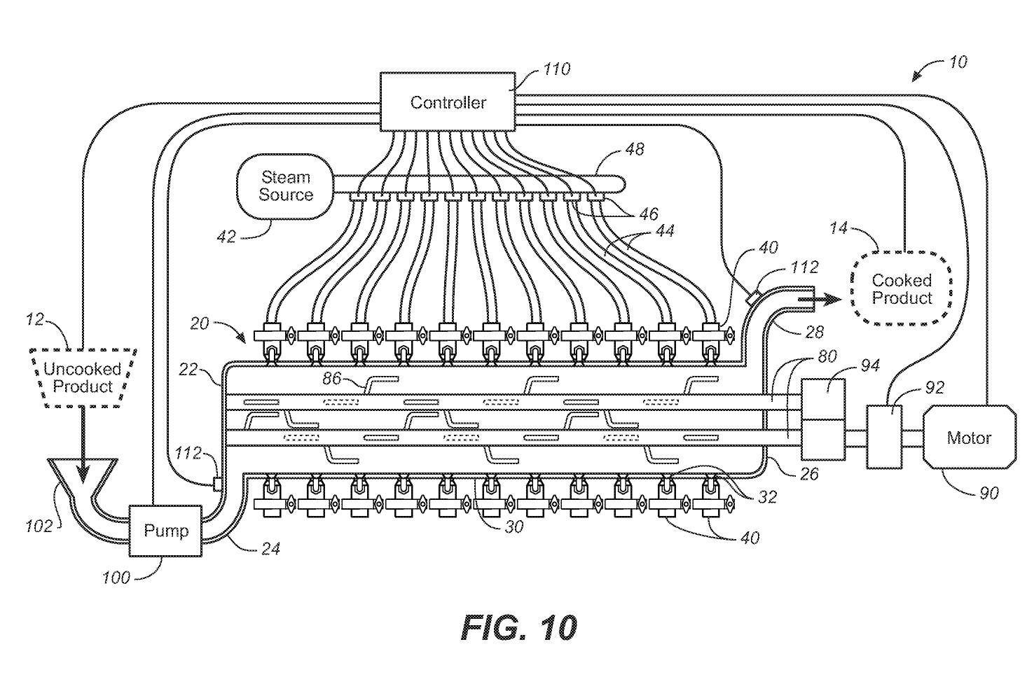

The product is conveyed in and through the cooking chamber 20 by a positive displacement type pump 100 (FIG. 10) near the cooking chamber inlet 22. A hopper 102, auger or another pump can be used to feed the displacement pump to insure that the pump is consistently supplied with food product.

The process variables that effect the cooked food quality are regulated by a controller 110 as shown in the schematic diagram (FIG. 10). There may be monitoring points such as temperature sensors and/or steam pressure sensors 112 on the inlet 22 and outlet 28 to register the cooked food temperature and pressure of the product.

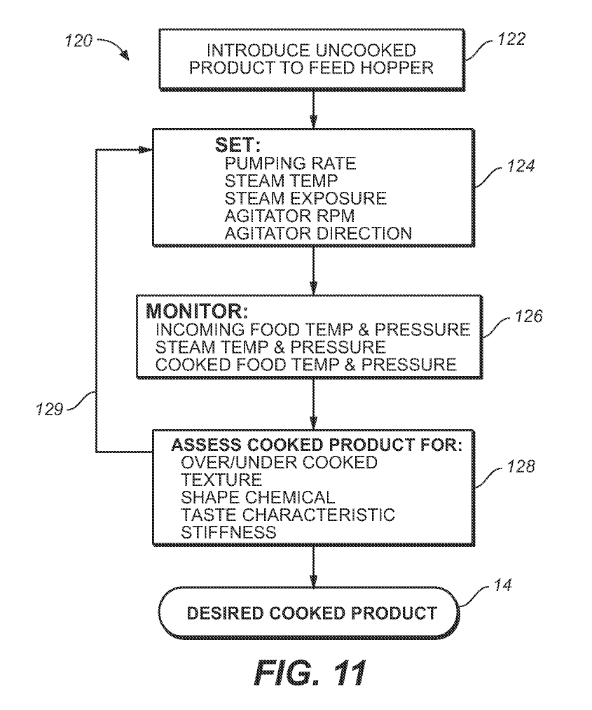

The process variables are identified in a flow chart (FIG. 11) describing the method of the present invention. The variables are listed in step 124 and are: (a) pumping rate; (b) quantity, temperature and location of hot steam introduced to the cooking chamber; and (c) the RPM and direction of the agitation.

In step 126 temperatures and pressure of incoming food, steam and outgoing cooked food are monitored.

In step 128 the cooked food product is assessed. Depending on the assessment will determine the feedback 129 to make changes to the variable parameters in step 124. The particular food product being cooked will determine the variable settings.

### EXAMPLE 1—Mozzarella Cheese Production

A typical target for pH of mozzarella cheese curd being fed into the mozzarella cooker would be 5.08 at a temperature of 80 degrees F. With a production rate of 5000 lbs per hour a typical inlet steam supply pressure would be 120 PSI, the injectors would be set to open in sequence starting with the first injector at the inlet of the cooker and to open as necessary to reach the set point temperature setting with a temperature setting of the outgoing, heated mozzarella cheese set at 140 degrees F. Ideally the agitator RPM would be set at 100 RPM. With the dual intermeshing agitator cooker one would expect these settings to produce excellent mozzarella cheese. If the pH of the cheese curd was 5.20 the set point temperature of the cooker would be raised to 145 degrees F. to compensate for the increased pH and minimize the loss of cheese moisture and milk solids. If the cheese came out of the cooker with evidence of small, unmelted cheese curd lumps the RPM speed of the agitators should be increased 5 RPM at a time until the evidence of the unmelted cheese curd disappeared. If the heated cheese had evidence of moisture and milk solids separation, the temperature setting of the cooker should be raised 1 degree F. at a time until the moisture separation disappeared. The steam pressure differential between the steam source and the product pressure inside of the cooking chamber must be maintained high enough to counteract the steam poppet spring to create a stable flow of steam through the injectors into the product cooking chamber.

### EXAMPLE 2—Beef Taco Meat Production

In the case of the cooking of ground beef taco meat, the incoming raw meat temperature would be approximately 35 degrees F. At a production rate of 5000 lbs per hour the cooked meat temperature set point would be set at 155 degrees F. and the agitator RPMs set at 250. The steam injector set up recommended is to spread out the heat input the length of the cooking column with the sequence of the opening of the injectors spaced out, opening every third injector until the temperature set point is reached. If the particle size of the cooked ground beef coming out of the cooker is too small the agitator RPM should be reduced 25 RPM at a time until the particle size is correct. If there are uncooked lumps of meat coming out of the cooking chamber the temperature set point should be increased by a few degrees or the agitator RPM increased by 25 RPM. If both the particle size is too small and the meat has uncooked lumps, location of the open steam injectors need to be moved closer to the inlet of the cooking chamber to allow for the heated meat to be exposed to the agitation in the cooking chamber for a longer period by adding the heat energy earlier in the process.

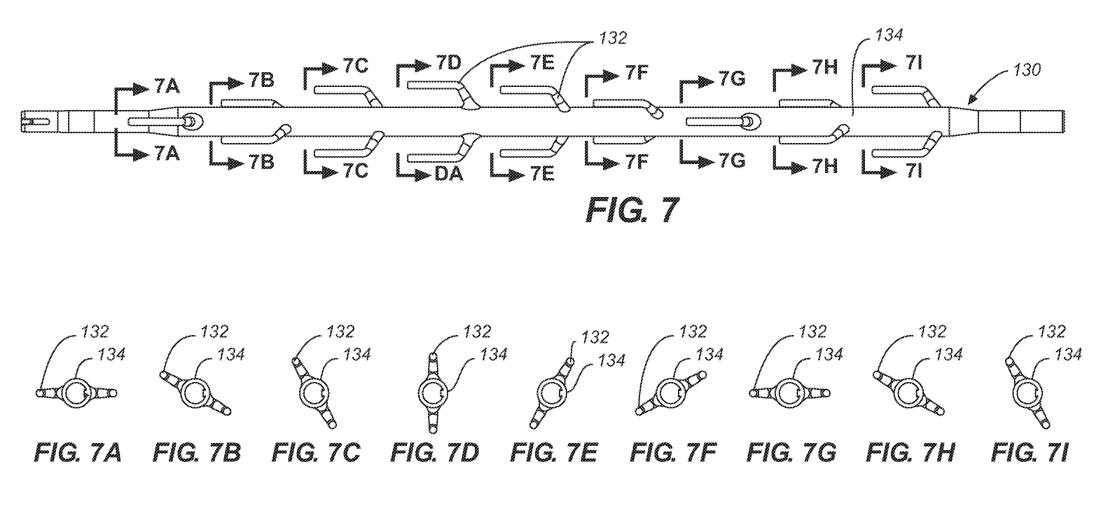

An alternate embodiment of an agitator is shown in FIG. 7. This agitator 130 has more arms 132 than agitator 80 which would increase the mixing rate while at the same RPM. The shaft 134 is larger and hollow.

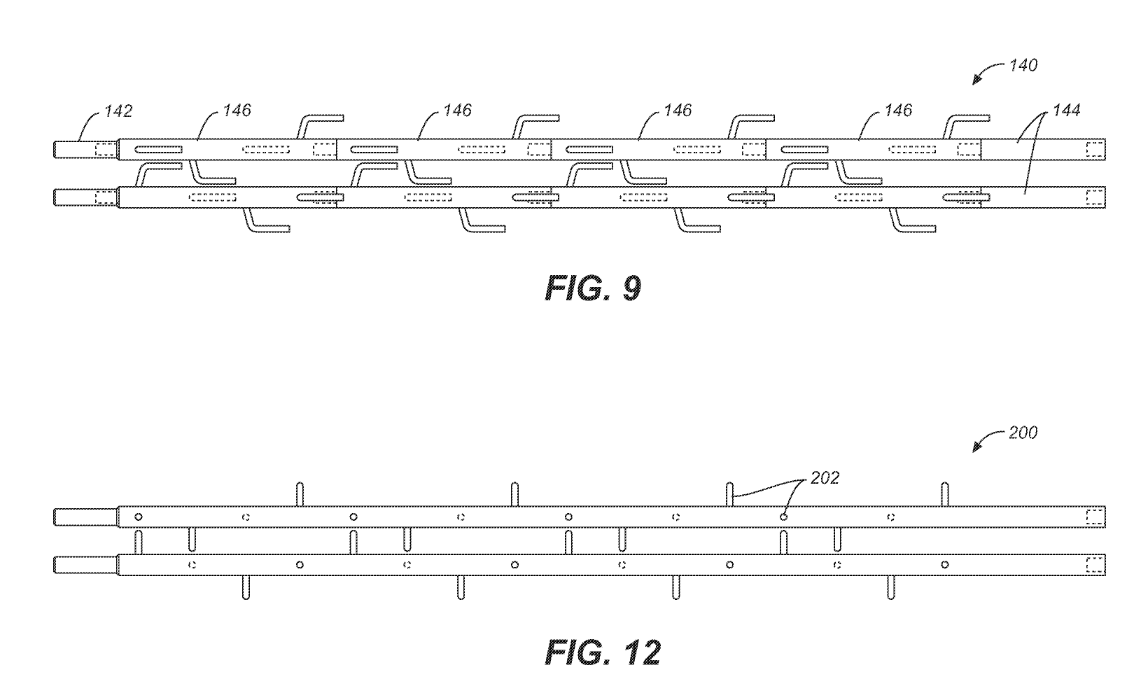

Another alternate embodiment of the agitator is shown in FIG. 9. This agitator 140 is segmented with the shaft having a distal end section 142 and a proximal end section 144. The center section can have one or more modules sections 146 added to lengthen the agitator. The shaft shown in FIG. 9 has four modules added. They are joined and pinned by complimentary male and female fittings integral to the ends of the modular sections.

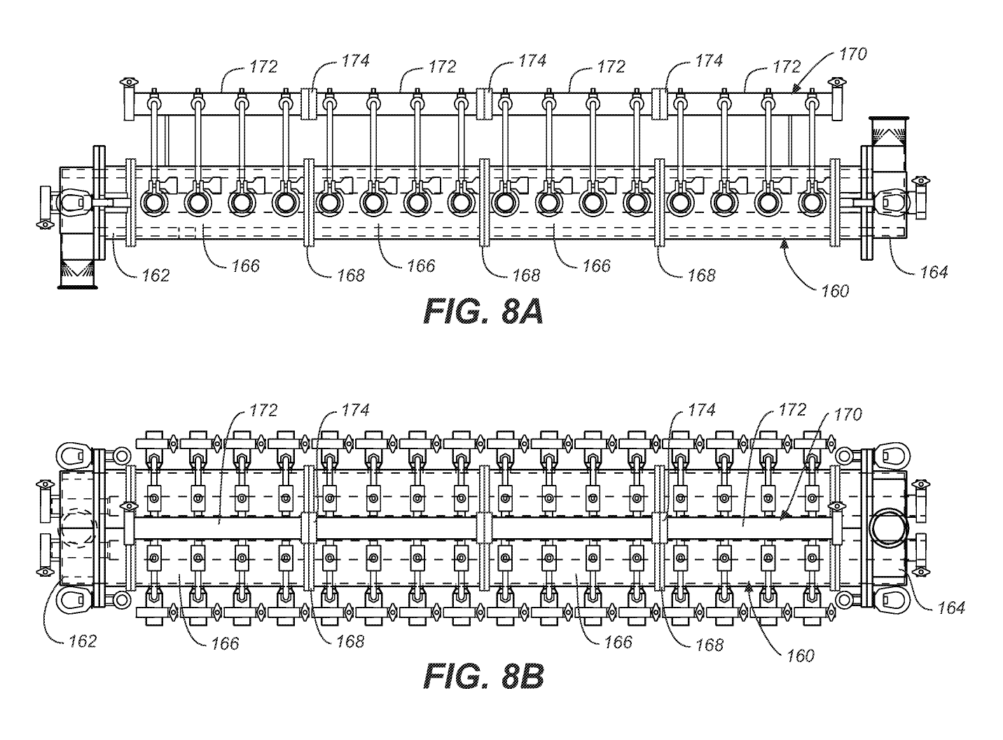

Agitators 140 are designed to be used with an alternate cooking chamber embodiment shown in FIGS. 8A and 8B. Cooking chamber 160 and steam manifold 170 are segmented so the size of the apparatus can be modified for greater or smaller throughput. Cooking chamber 160 has an inlet side 162 and an outlet side 164. In between are modular sections 166 that can extend or shorten the length of the cooker. They are removably fastened together at joints 168 and have steam inlets in their walls. In a similar manner a steam manifold 170 is in sections to allow lengthening or shortening by adding or subtracting modules 172 and are fastened together at joints 174.

FIG. 12 shows yet another alternative embodiment 200 of the agitator arms of the present invention, in this instance comprising a radial spoke configuration. The intermeshing aspect of the invention is obviated by this configuration, inasmuch as simple linear spacing of the arms 202 along the length of the agitator shafts will suffice to prevent interference of the agitator elements. In this embodiment, as with the prior embodiments, the agitator arms can be shaped in either a cylindrical or tear-drop shape. Sufficient kneading, pulling, and stretching of the developing pasta filata cheese.

The foregoing description and illustrations should not be construed as limiting the scope of the invention, which is defined by the appended claims.

What is claimed as invention is:

1. A continuous food cooking apparatus comprising:
a process chamber having a top side and a bottom side and at least one interior wall, and with a product inlet at one end and a cooked product outlet at the opposite end;
product conveying means disposed prior to and exterior to said product inlet of said process chamber;
a plurality of steam inlet ports disposed on said at least one interior wall of said process chamber between said product inlet and said product outlet;
a plurality of non-conveying agitators located within said process chamber communicating and driven by a means exterior to said process chamber.

2. The apparatus of claim 1 wherein said product outlet is located on said top side of said process chamber.

3. The apparatus of claim 1 wherein said product inlet is located on said bottom side of said process chamber.

4. The apparatus of claim 1 wherein said product conveying means comprises at least one positive displacement pump.

5. The apparatus of claim 1, wherein said product conveying means comprises a combination of at least one screw auger and at least one positive displacement pump.

6. The apparatus of claim 1, wherein said steam inlet ports are normally closed poppet valves.

7. The apparatus of claim 6, wherein each of said poppet valves, when opened, release steam in a substantially tangential trajectory to the plane of said at least one interior wall of said process chamber proximate the location said steam inlet port is located.

8. The apparatus of claim 6, wherein each of said poppet valves, when opened, releases steam radially in a plane normal to the axis of said inlet port.

9. The apparatus of claim 6, wherein each of said poppet valves, when opened, releases steam radially in a conical flare having a vertex proximate said steam inlet port and a base extending said process chamber.

10. The apparatus of claim 1, wherein said steam inlet ports are discretely controlled relative to temperature of steam.

11. The apparatus of claim 1, wherein said steam inlet ports are discretely controlled relative to opening and closing duration time.

12. The apparatus of claim 1, wherein said steam inlet ports are discretely controlled relative to temperature of steam and opening and closing duration time.

13. The apparatus of claim 1, wherein said agitators have radially depending, non-intersecting, arms.

14. The apparatus of claim 1, wherein said agitators have radially depending, overlapping, intermeshing, non-intersecting, arms.

15. The apparatus of claim 1, wherein said agitators have radically depending, intermeshing, arms shaped such that when rotated in one direction they impart minimal shear to the product, and when rotated in the opposite direction impart high shear to the product.

16. The apparatus of claim 1, wherein said process chamber and agitators are composed of modular segments.

17. The apparatus of claim 1, further including inlet feed pumps disposed at said inlet port, and a control system, wherein said inlet feed pumps at said inlet port, said steam inlet ports, and said agitators are independently controlled and collectively considered to affect the resulting cooked product at said outlet of said apparatus.

18. A method for the continuous cooking of food product in a cooking chamber utilizing steam, feed pump(s), and non-conveying agitators, wherein, the food product is cooked by the introduction of steam, the surface of the product being constantly modified by non-conveying agitators, and wherein the speed and direction of the non-conveying agitators determines the outcome and quality of the cooked product.

19. The method of claim 18, further including the step of controlling the outcome and characteristics of the cooked food product using the locations and temperature of steam disbursement within the cooking chamber.

20. A method for the continuous cooking of food in a cooking chamber in claim 18 where in the speed and direction of the non-conveying agitators and the locations and temperature of steam disbursement determines the outcome and quality of the cooked product.

21. A method for the continuous cooking of food in a cooking chamber utilizing steam, pump(s) and non-conveying agitators, wherein the product is cooked by the introduction of steam that is bathed over the surface of the product, the surface of the product being constantly modified by non-conveying agitators, and where in the speed and direction of the non-conveying agitators, the locations and temperature of steam disbursement determines the outcome and quality of the cooked product.
